(19) United States
(12) Patent Application Publication
(10) Pub. No.: US 2025/0251768 A1
(43) Pub. Date: Aug. 7, 2025

(54) POWER SUPPLY CONTROL CIRCUITRY AND INFORMATION PROCESSING APPARATUS

(71) Applicant: Fujitsu Limited, Kawasaki-shi (JP)

(72) Inventors: Takuya TANIMURA, Sagamihara (JP); Fujio KUROKAWA, Nagasaki (JP)

(73) Assignee: Fujitsu Limited, Kawasaki-shi (JP)

(21) Appl. No.: 19/009,779

(22) Filed: Jan. 3, 2025

(30) Foreign Application Priority Data
Feb. 5, 2024 (JP) 2024-015588

(51) Int. Cl. G06F 1/26; G06F 1/3296

(52) U.S. Cl. CPC G06F 1/263; G06F 1/3296

(57) ABSTRACT

Power supply control circuitry connected to power supply units, includes a storing device that stores information indicating a relationship between load rates for a load and power conversion efficiencies of the units at the load rates, for each input voltage input to a converter provided in each unit and outputs a voltage to the load, and for each number of units in a power supplying state, and control circuitry that determines a trigger for increasing or decreasing a number of units in the state, based on the load rates, the input voltages and the relationship, and sends, in response to determining that the trigger is met, an instruction to turn on or off the state to each of the units so that the number of units in the state matches an identified number of units based on the load rates, the input voltages and the relationship.

### CROSS-REFERENCE TO RELATED APPLICATION

This application is based upon and claims the benefit of priority of the prior Japanese Patent application No. 2024-015588, filed on February 5, 2024, the entire contents of which are incorporated herein by reference.

### FIELD

The present disclosure relates to power supply control circuitry and an information processing apparatus.

### BACKGROUND

Methods for reducing the power consumption of an information processing apparatus by improving the power efficiency of a power supply apparatus, which supplies the power to the information processing apparatus, e.g., a power supply unit (PSU), are known.

For example, a power supply apparatus detects changes in the voltage of a direct current power source connected to the input terminal controls thereof, the input voltage intermittently based on a pulse train signal with a duty cycle according to the detected result and the voltage setting data corresponding to the desired output voltage, and smoothes the resulting voltage to generate the output voltage.

For example, a related art is disclosed in Japanese Laid-Open Patent Publication No. 2002-159173.

### SUMMARY

According to an aspect of the embodiments, power supply control circuitry configured to control a plurality of power supply units connected to a load, includes a storing device and control circuitry. The storing device is configured to store information indicating a correspondence relationship between load rates for the load and power conversion efficiencies of the plurality of power supply units at the load rates, for each input voltage input to a voltage converter provided in each of the plurality of power supply units and configured to output an output voltage to the load, and for each number of power supply units in a power supplying state for supplying power to the load. The control circuitry is configured to determine a trigger for increasing or decreasing a number of power supply units in the power supplying state, based on the load rates and the input voltages obtained from the plurality of power supply units and the correspondence relationship. The control circuitry is configured to send, in response to determining that the trigger for increasing or decreasing the number of units is met, an instruction to turn on or off the power supplying state to each of the plurality of power supply units so that the number of power supply units in the power supplying state matches a number of units identified based on the load rates and the input voltages obtained and the correspondence relationship.

According to another aspect of the embodiments, power supply control circuitry configured to control a plurality of power supply units connected to a load, includes a storing device and control circuitry. The storing device is configured to store information indicating a correspondence relationship between load rates for the load and power conversion efficiencies of the plurality of power supply units at the load rates, for each temperature of a voltage converter provided in each of the plurality of power supply units and configured to output an output voltage to the load, and for each number of power supply units in the power supplying state supplying power to the load. The control circuitry is configured to determine a trigger for increasing or decreasing a number of power supply units in the power supplying state, based on the load rates and the temperatures obtained from the plurality of power supply units and the correspondence relationship. The control circuitry is configured to send, in response to determining that the trigger for increasing or decreasing the number of units is met, an instruction to turn on or off the power supplying state to each of the plurality of power supply units so that the number of power supply units in the power supplying state matches a number of units identified based on the load rates and the temperatures obtained and the correspondence relationship.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an exemplary hardware configuration of an apparatus according to a first embodiment;

FIG. 2 is a block diagram illustrating an exemplary hardware configuration of a power supply unit according to the first embodiment;

FIG. 3 is a graph indicating one example of the relationship between the power conversion efficiency and the load rate of a power supply unit;

FIG. 4 is a graph indicating one example of the relationship between the power conversion efficiency and the load rate in different numbers of power supply units;

FIG. 5 is a graph indicating one example of the relationship between the power conversion efficiency and the load rate when the input voltage to the DC (direct current)-DC converter varies;

FIG. 6 is a graph indicating one example of the relationship between the power conversion efficiency and the load rate in different numbers of power supply units and when the input voltage to the DC-DC converter is high and low;

FIG. 7 is a block diagram illustrating an exemplary hardware configuration of a power supply unit according to a comparative example;

FIG. 8 is a block diagram illustrating an exemplary functional configuration of a power supply controller according to the first embodiment;

FIG. 9 is a diagram illustrating one example of the relationship between load modes and operating settings of the power supply units;

FIG. 10 is a diagram illustrating one example of the ranges of the load rates for load modes according to the input voltage to the DC-DC converter;

FIG. 11 is a diagram illustrating one example of a power conversion efficiency table;

FIG. 12 is a diagram illustrating examples of efficiency curves represented by the power conversion efficiency table;

FIG. 13 is a flowchart for explaining an exemplary operation of the apparatus according to the first embodiment;

FIG. 14 is a diagram illustrating one example of the triggers for switching the number of units to operate according to the input voltage;

FIG. 15 is a block diagram illustrating an exemplary hardware configuration of a power supply unit according to a second embodiment;

FIG. 16 is a block diagram illustrating an exemplary functional configuration of a power supply controller according to the second embodiment;

FIG. 17 is a diagram illustrating one example of the relationship between load modes and operating settings of the power supply units;

FIG. 18 is a graph indicating one example of the relationship between the power conversion efficiency and the load rate when the component temperature in the DC-DC converter varies;

FIG. 19 is a diagram illustrating one example of the ranges of the load rates for load modes according to the component temperature in the DC-DC converter;

FIG. 20 is a diagram illustrating one example of a power conversion efficiency table;

FIG. 21 is a diagram illustrating one example of an efficiency curve represented by the power conversion efficiency table;

FIG. 22 is a flowchart for explaining an exemplary operation of the apparatus according to the second embodiment;

FIG. 23 is a diagram illustrating one example of power conversion efficiencies by switching the number of units to operate according to component temperature;

FIG. 24 is a block diagram illustrating an exemplary hardware configuration of a power supply unit according to a third embodiment; and

FIG. 25 is a block diagram illustrating an exemplary functional configuration of a power supply controller according to the third embodiment.

### DESCRIPTION OF EMBODIMENT(S)

In computers (information processing apparatuses) requiring high reliability, such as servers, a power supply apparatus having a plurality of power supply units in a redundant configuration may be used to reduce the possibility of system down due to failures of the power supply units.

In the above-mentioned approach, however, a plurality of power supply units in a redundant configuration are not considered, making it difficult to improve the power efficiency of the entire power supply apparatus under a redundant operation of the plurality of power supply units. Furthermore, the power efficiency of each power supply unit can fluctuate due to various factors, making it challenging to improve the power efficiency of the entire power supply apparatus while adapting to these fluctuations.

Hereinafter, embodiments of the present disclosure will be described with reference to the drawings. However, the embodiments described below are merely illustrative, and there is no intention to exclude various modifications or applications of technology that are not explicitly described. For example, the present embodiments can be modified in various ways without departing from the spirit thereof. In the drawings used in the following descriptions, elements denoted by the same reference symbols represent the same or similar elements unless otherwise specified.

### (A) First Embodiment

### (A-1) Exemplary Configuration of Apparatus

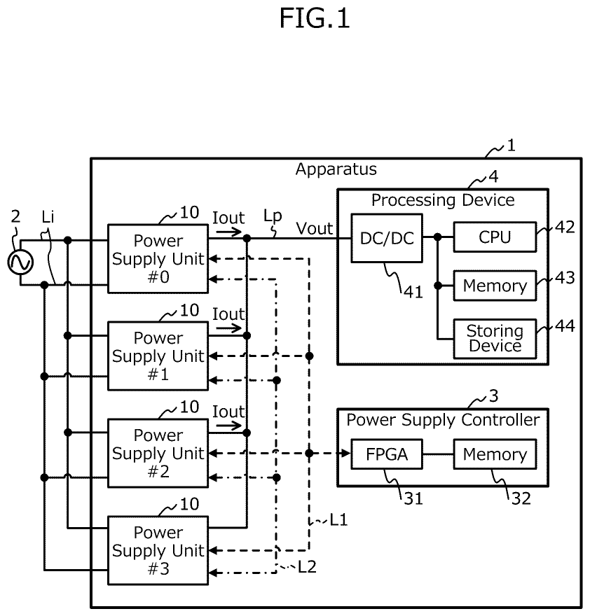

FIG. 1 is a block diagram illustrating an exemplary hardware configuration of an apparatus 1 according to a first embodiment. The apparatus 1 is one example of a computer, information processing apparatus, or information processing system operating on alternating current (AC) power supplied from an external AC power source 2. As illustrated in FIG. 1, the apparatus 1 may include a plurality of (four in FIG. 1) power supply units 10 (denoted as power supply units #0 to #3 in FIG. 1), a power supply controller 3, and a processing device 4. The plurality of power supply units 10 and the power supply controller 3 represent one example of a power supply apparatus or power supply system.

Each power supply unit 10 is connected to a common output line Lp. In the following description, an example is given where the apparatus 1 includes the four power supply units #0 to #3, but the number of power supply units 10 in the apparatus 1 may be appropriately increased or decreased according to the power consumption by the processing device 4, etc. Furthermore, although the plurality of power supply units 10 are assumed to have similar specifications (performances) to each other in the first embodiment, the specifications of the power supply units 10 may be different from each other.

The power supply controller 3 represents one example of power supply control circuitry configured to control a plurality of power supply units 10 connected to a load. The power supply controller 3 is communicatively connected to each of the power supply units #0 to #3 via a signal line L1. The power supply controller 3 controls each of the power supply units #0 to #3 by outputting a control signal S1 to the signal line L1.

The power supply controller 3 may include, for example, an Field-Programmable Gate Array (FPGA, circuitry) 31 and a memory 32.

The FPGA 31 represents one example of a processor or arithmetic processing device that performs various controls and arithmetic processing in the power supply controller 3 and represents one example of control circuitry. Instead of the FPGA 31, the power supply controller 3 may include various types of integrated circuits (ICs), such as a Central Processing Unit (CPU) or Application-Specific Integrated Circuit (ASIC).

The memory 32 represents one example of a storing device configured to store various types of information, such as data and programs, used in the power supply controller 3. The memory 32 may store, for example, firmware (FW) and control information used to implement the functions of the power supply controller 3, to be described below. Examples of the memory 32 include various types of non-volatile memory, such as Storage Class Memory (SCM) and Read Only Memory (ROM).

The processing device 4 is, for example, a processing functional unit that performs information processing in the apparatus 1, and represents one example of a “load” in the apparatus 1. The processing device 4 is connected to output lines Lp of the plurality of power supply units 10 and operates on power supplied from the plurality of power supply units 10 via the output lines Lp.

The processing device 4 may include, for example, a DC (Direct Current)-DC converter 41, a CPU 42, a memory 43, and a storing device 44. Hereinafter, the “DC-DC converter” may be referred to as “DC/DC.”

The DC-DC converter 41 converts (for example, steps down) an output voltage (DC voltage) Vout applied to the output line Lp into the respective operating voltages of the CPU 42, the memory 43, and the storing device 44, and outputs the respective converted voltages to the CPU 42, the memory 43, and the storing device 44.

The CPU 42 represents one example of a processor or arithmetic processing device configured to perform various controls and arithmetic processing in the processing device 4.

The memory 43 and the storing device 44 each store various types of information, such as data and programs, utilized in the processing device 4. Examples of the memory 43 include either or both of volatile memory such as a Dynamic Random Access Memory (DRAM) and non-volatile memory such as SCM, for example. Examples of the storing device 44 include various storing devices such as magnetic disk devices, e.g., an Hard Disk Drive (HDD), semiconductor drive devices, e.g., Solid State Drive (SSD), and non-volatile memory.

It should be noted that the processing device 4 is not limited to the above-described computer component and may be any of various types of electrical devices or electronic devices.

Each power supply unit 10 converts AC power supplied from an AC power source 2 into DC power, and supplies the DC power to the processing device 4 via the output line Lp. Additionally, the power supply units 10 are communicatively connected to each other via a signal line L2. When in a power supplying state, a power supply unit 10 sends and receives current balance signals S2 to and from other power supply units 10 via the signal line L2 to match the magnitude of output current.

Here, the power supplying state refers to the state where power is being supplied to the processing device 4. In contrast, the state where power supply to the processing device 4 is stopped is referred to as the stop state. Each power supply unit 10 can individually switch between the power supplying state and the stop state according to instructions from the power supply controller 3.

### (A-2) Exemplary Configuration of Power Supply Unit

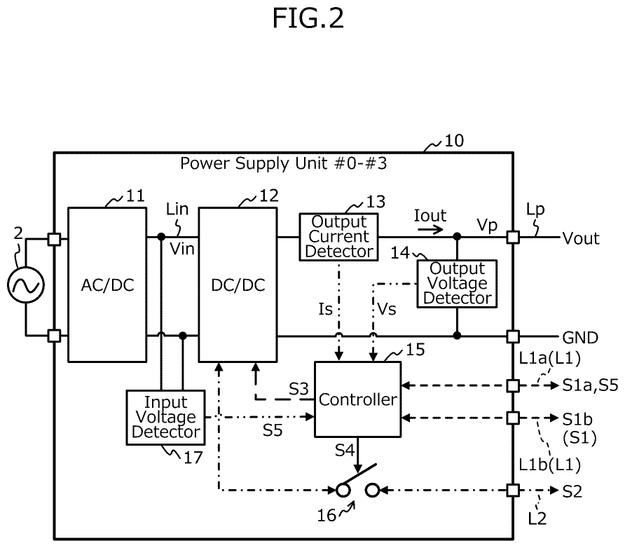

FIG. 2 is a block diagram illustrating an exemplary hardware configuration of a power supply unit 10 according to the first embodiment. Each power supply unit 10 (#0 to #3) according to the first embodiment may include an Alternating Current (AC)-DC converter 11, a DC-DC converter 12, an output current detector 13, an output voltage detector 14, a controller 15, a switch 16, and an input voltage detector 17. Hereinafter, the “AC-DC converter” may be referred to as “AC/DC.”

The AC-DC converter 11 converts AC power supplied from the external AC power source 2 into DC power and outputs the DC power to an input line Lin to the DC-DC converter 12. It should be noted that the AC-DC converter 11 may also include a power factor correction (PFC) circuit.

The DC-DC converter 12 represents one example of a voltage converter or voltage output unit (circuitry) that outputs an output voltage to the processing device 4. The DC-DC converter 12 steps down an input voltage Vin that is a DC voltage applied to the input line Lin by the AC-DC converter 11, and applies (outputs) a DC output voltage Vp resulting from the stepping down to an output line Lp. Additionally, the DC-DC converter 12 is connected to the signal line L2 and sends and receives a current balance signal S2 to and from other power supply units 10 via the signal lines L2.

The output voltage Vp output from the DC-DC converter 12 to the output line Lp and an output current Iout flowing through the output line Lp vary according to the operating state (operational state, namely, the power supplying state or stop state) of its local power supply unit 10.

In the power supplying state, the DC-DC converter 12 outputs an output voltage Vp (output voltage Vout) with a voltage value V1. Accordingly, when any one of the power supply units #0 to #3 supplies power to the processing device 4, the voltage value on the output line Lp assumes V1. The current value of output current Iout from the DC-DC converter 12 in the power supplying state is determined according to the power consumption by the processing device 4 and is adjusted by a current balancing function that matches the magnitude of the output current Iout with those from other power supply units 10 in the power supplying state.

In the stop state, the DC-DC converter 12 maintains to output a voltage but outputs an output voltage Vp with a voltage value V2, which is slightly lower than the voltage value V1 in the power supplying state. The voltage value V2 may be, for example, about 80% to 98% of the voltage value V1. Since the voltage value V2 of the output voltage Vp from the DC-DC converter 12 in the stop state is lower than the voltage value V1 of the output voltage Vout on the output line Lp, no current is output from the DC-DC converter 12 in the stop state. In other words, the current value of output current Iout from the DC-DC converter 12 in the stop state is zero.

The output current detector 13 is, for example, any of various types of sensors to measure the magnitude of the current and outputs a current detection signal Is indicating the magnitude of the output current Iout from the DC-DC converter 12, to the controller 15.

The output voltage detector 14 is, for example, any of various types of sensors to measure the magnitude of a voltage and outputs a voltage detection signal Vs indicating the magnitude of the output voltage Vp on the output line Lp, to the controller 15.

The controller 15 is connected to signal lines L1a and L1b, and performs communications with the power supply controller 3 via the signal lines L1a and L1b. The signal lines L1a and L1b are examples of the signal line L1 illustrated in FIG. 1. It should be noted that the signal line L1 (either or both of L1a and L1b) may be, for example, a communication bus compliant with a communication standard such as Power Management Bus (PMBus).

The controller 15 supplies (outputs) a signal S1a to the power supply controller 3 via the signal line L1a, for example. The signal S1a is a signal indicating the load rate β for the power supply unit 10. Since the plurality of power supply units 10 are connected to the processing device 4, the load rate β represents one example of the load rate for the processing device 4. The controller 15 calculates the load rate β of its local power supply unit 10 based on the current detection signal Is and the voltage detection signal Vs, and the rated output value of its local power supply unit 10.

The controller 15 calculates the output power value Po from the DC-DC converter 12 based on, for example, the current detection signal Is and the voltage detection signal Vs according to the following formula (1). In the formula (1), the output voltage value V is the value of the output voltage Vp indicated by the voltage detection signal Vs, and the output current value I is the value of the output current Iout indicated by the current detection signal Is.

Output power value Po=output voltage value V*output current value I (1)

The controller 15 then calculates the load rate β of its local power supply unit 10 based on the calculated output power value Po and the rated power value Pr, which is one example of the rated output value, according to the following formula (2). The rated power value Pr is the power value when the power supply unit 10 supplies power under given conditions and may be defined in advance for each power supply unit 10. As indicated in the formula (2), the load rate β represents the proportion of the output power value Po relative to the rated power value Pr.

Load rate β=output power value Po/rated power value Pr (2)

An operation control signal S1b is supplied (input) to the controller 15 from the power supply controller 3 via the signal line L1b. The operation control signal S1b is a signal for controlling the output state (operating state, operation state) of the power supply unit 10 and represents one example of the control signal S1 illustrated in FIG. 1.

As one example, if the value is at a low level (Low), the operation control signal S1b indicates that the output state of the power supply unit 10 is set to the power supplying state; for example, if already in the power supplying state, the current output state is to be maintained; if in the stop state, the output state is to be transitioned to the power supplying state. Once the power supply unit 10 transitions to the power supplying state, it supplies power to the processing device 4 along with other power supply unit(s) 10 already in the power supplying state. Conversely, as one example, if the value is at a high level (High), the operation control signal S1b indicates that the output state of the power supply unit 10 is set to the stop state; for example, if already in the stop state, the current output state is to be maintained; if in the power supplying state, the output state is to be transitions to the stop state.

Based on the value indicated by the operation control signal S1b, the controller 15 supplies an output setting signal S3 to the DC-DC converter 12 to set the output state of its local power supply unit 10 to either the power supplying state or the stop state.

For example, if the value of the operation control signal S1b indicates the low level, the controller 15 sets the output setting signal S3 supplied to the DC-DC converter 12 to the low level, thereby setting the DC-DC converter 12 to the power supplying state. Conversely, if the value of the operation control signal S1b indicates the high level, the controller 15 sets the output setting signal S3 supplied to the DC-DC converter 12 to the high level, thereby setting the DC-DC converter 12 to the stop state.

Additionally, based on the value indicated by the operation control signal S1b, the controller 15 supplies a switch control signal S4 to the switch 16 provided on the signal line L2 to control the connection state of the switch 16 to either the on (connected) or off (disconnected) state.

As one example, the switch 16 controls (switches) the connection state to the on state when the value of the switch control signal S4 indicates the low level (Low). The controller 15 controls the switch 16 to the on state to enable the transmission and reception of the current balance signal S2 in the local DC-DC converter 12, thereby activating the current balancing function.

Alternatively, the switch 16, as an example, controls (switches) the connection state to the OFF state when the value of the switch control signal S4 indicates the high level (High). The controller 15 controls the switch 16 to the OFF state to disable the transmission and reception of the current balance signal S2 in the local DC-DC converter 12, thereby deactivating the current balancing function. Consequently, the output voltage from the DC-DC converter 12 in the stop state is stabilized.

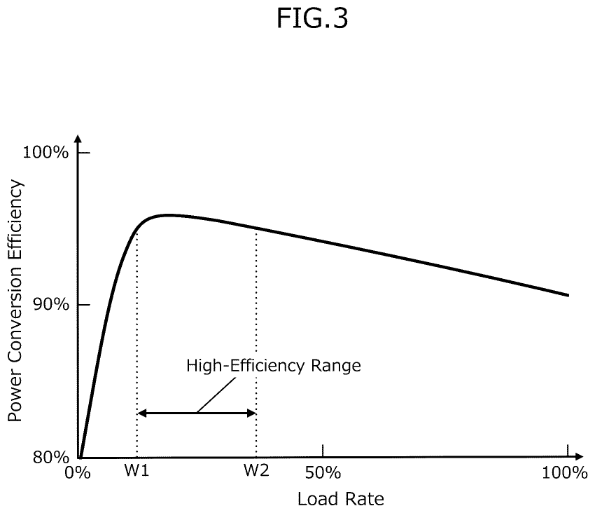

FIG. 3 is a graph indicating one example of the relationship between the power conversion efficiency and the load rate of the power supply unit 10. The power conversion efficiency represents one example of the power efficiency of the power supply unit 10. As illustrated in FIG. 3, the power conversion efficiency of the power supply unit 10 varies with the load rate, and has a peak at a certain load rate. Hereinafter, a curve (graph) depicting the relationship between the power conversion efficiency and the load rate as illustrated in FIG. 3 may be referred to as an “efficiency curve.”

For each power supply unit 10, the range of the load rate from W1 to W2 is defined as the high-efficiency range where the power conversion efficiency is relatively high. The high-efficiency range may be defined as the range where the power conversion efficiency of the power supply unit 10 exceeds a given value (e.g., 95%). It should be noted that W1 and W2 which define the high-efficiency range vary depending on the specifications (characteristics) of the power supply units 10.

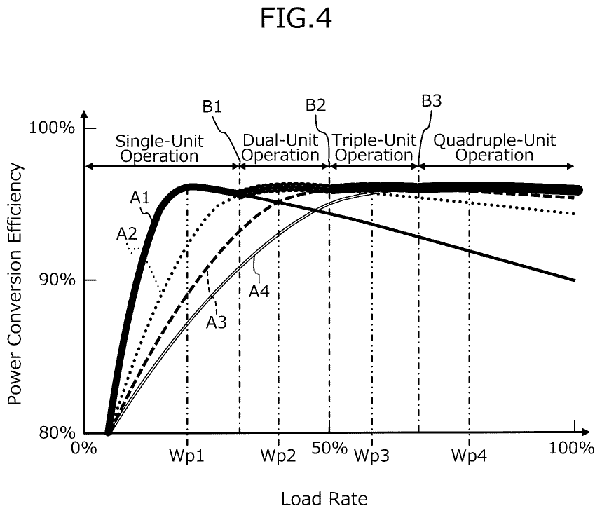

FIG. 4 is a graph indicating one example of the relationship between the power conversion efficiency and the load rate in different numbers of power supply units 10. In FIG. 4, “operation” may mean that the power supply units 10 are in the power supplying state. For example, “single-unit operation” means that either one of power supply units #0 to #3 is in the power supplying state, while the remaining three units are in the stop state. In FIG. 4, the symbol A1 indicates one example of the efficiency curve per power supply unit 10 in single-unit operation, A2 in dual-unit operation, A3 in triple-unit operation, and A4 in quadruple-unit operation. When multiple power supply units 10 with the same rated output value operate in parallel, the load rate of each operating power supply unit 10 is the same.

As illustrated in FIG. 4, when the load rates at which the power conversion efficiency peaks for single-, dual-, triple-, and quadruple-unit operation are denoted by Wp1, Wp2, Wp3, and Wp4, respectively, then Wp1<Wp2<Wp3<Wp4. In this manner, as the number of operating power supply units 10 increases, the high-efficiency range shifts toward the higher load side.

This means that the power conversion efficiency can be optimized for a certain load rate by operating power supply units 10 in the number that corresponds to the efficiency curves (A1 to A4) giving the maximum power conversion efficiency at that load rate. For example, as indicated by the bold ridgeline in FIG. 4, single-unit operation is optimal from a load rate of 0% to the load rate B1 where the efficiency curves of the symbols A1 and A2 intersect, and dual-unit operation is optimal from the load rate B1 to the load rate B2 where the efficiency curves of the symbols A2 and A3 intersect. Furthermore, triple-unit operation is optimal from the load rate B2 to the load rate B3 where the efficiency curves of the symbols A3 and A4 intersect, and quadruple-unit operation is optimal at the load rate B3 or higher.

The power supply controller 3 calculates the load rate of the plurality of power supply units 10 as a whole based on the signal S1a received from each of the plurality of power supply units 10, then determines the optimal number of power supply units 10 to be operated according to the calculated load rate. The power supply controller 3 sends an operation control signal S1b to each power supply unit 10 to place only power supply unit(s) 10 in the determined number in the power supplying state and set the remaining (unnecessary) power supply unit(s) 10 to the stop state. This allows the power supply units 10 to operate at optimal power conversion efficiency along the bold ridgeline indicated in FIG. 4.

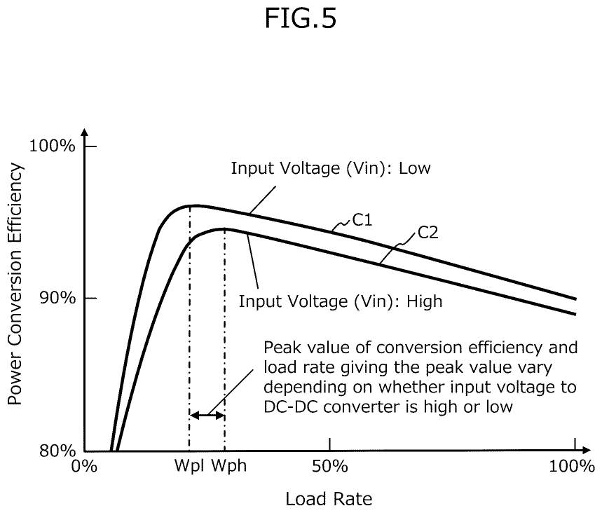

FIG. 5 is a graph indicating one example of the relationship between the power conversion efficiency and the load rate when the input voltage Vin to the DC-DC converter 12 varies. FIG. 5 illustrates the efficiency curves in cases where the input voltage Vin to the DC-DC converter 12 is low (symbol C1) and high (symbol C2) during single-unit operation of a power supply unit 10.

As illustrated in FIG. 5, the peak value on the efficiency curve of the power supply unit 10 (power conversion efficiency) and the load rate giving this peak value vary depending on the input voltage Vin to the DC-DC converter 12. In FIG. 5, Wpl represents the load rate giving the peak value of the efficiency curve C1 when the input voltage Vin is relatively low compared to a given reference, and Wph represents the load rate giving the peak value of the efficiency curve C2 when the input voltage Vin is relatively high compared to the given reference. Although Wpl<Wph in the example in FIG. 5, Wpl>Wph may be applied depending on the specifications of the power supply units 10, etc.

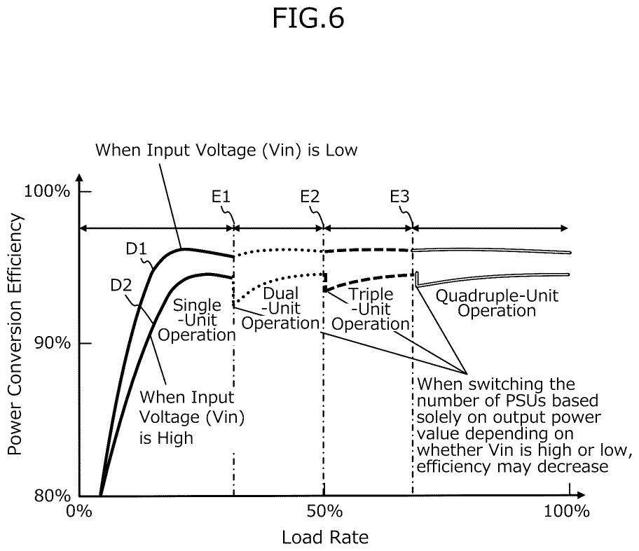

FIG. 6 is a graph indicating one example of the relationship between the power conversion efficiency and the load rate in different numbers of power supply units 10 and when the input voltage Vin to the DC-DC converter 12 is high and low. In FIG. 6, the ridgeline D1 represents the optimal efficiency curve of the power conversion efficiency and the load rate when the number of power supply units 10 is increased or decreased at load rates E1, E2, and E3 when the input voltage Vin is low. The ridgeline D2 represents the efficiency curve when the number of power supply units 10 is increased or decreased at the load rates E1, E2, and E3 when the input voltage Vin is high.

The load rate at the peak value on the efficiency curve varies according to whether the input voltage Vin is high or low (see FIG. 5). Accordingly, for example, when the input voltage Vin is high, if the number of power supply units 10 (output voltage) is switched at the optimal load rates E1, E2, or E3, which are the optimal timing for switching the number of power supply units 10 when the input voltage Vin is low, the power conversion efficiency may be decreased.

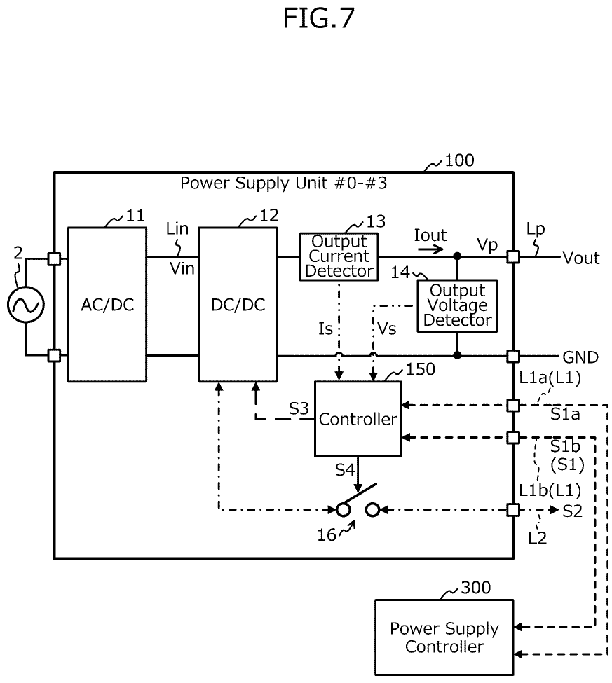

In this case, the power supply unit 10 that includes the AC-DC converter 11, the DC-DC converter 12, the output current detector 13, the output voltage detector 14, the controller 15, and the switch 16 can be considered equivalent to a power supply unit 100 illustrated in FIG. 7.

FIG. 7 is a block diagram illustrating an exemplary hardware configuration of the power supply unit 100 in a comparative example. As illustrated in FIG. 7, the power supply unit 100 does not include the input voltage detector 17 illustrated in FIG. 2. Furthermore, the power supply unit 100 has a controller 150 that only sends output power values Po (load rates β) as signals S1a to a power supply controller 300, as information obtained from power supply units 100. In other words, in the comparative example, the power supply controller 300 increases or decreases the number of operating power supply units 100 relying solely on the monitoring of the output power values Po (load rates β) from the power supply units 100 among various pieces of information obtained from the power supply units 100.

In this manner, the approach of the comparative example, which increases or decreases the number of the power supply units 100 to be operated relying solely on the monitoring of the output power values Po (load rates β) from the of power supply units 100 may not adequately adapt to variations in the input voltage Vin, potentially resulting in reduced power conversion efficiency, as described with reference to FIGS. 5 and 6. Consequently, the approach of the comparative example may not achieve highly precise and optimal high efficiency of the power supply units 100.

Therefore, the power supply unit 10 according to the first embodiment detects the input voltage Vin to the DC-DC converter 12 and outputs it to the power supply controller 3.

Referring back to the description in FIG. 2, the input voltage detector 17 is, for example, any of various sensors that measure the magnitude of voltage, and outputs a voltage detection signal S5 indicating the magnitude of the input voltage Vin on the input line Lin on the input side of the DC-DC converter 12 (the output side of the AC-DC converter 11), to the controller 15. The magnitude of the input voltage Vin is, for example, the potential difference between the input line Lin and GND. It should be noted that the input voltage detector 17 may be implemented by an Analog Digital Converter (ADC) provided in the controller 15 or the like, for example.

The controller 15 sends (outputs) the voltage detection signal S5, along with the signal S1a indicating the load rate β, to the power supply controller 3 via the signal line L1a.

### (A-3) Exemplary Configuration of Power Supply Controller

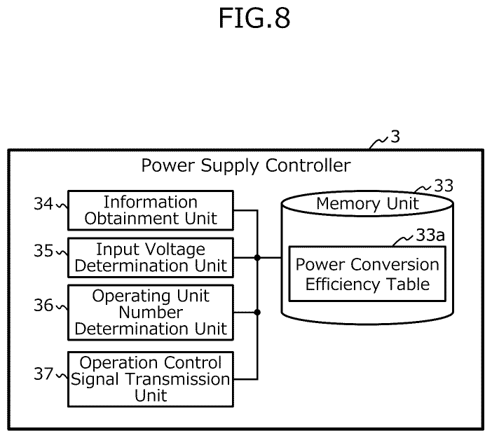

FIG. 8 is a block diagram illustrating an exemplary functional configuration of the power supply controller 3 according to the first embodiment. As illustrated in FIG. 8, the power supply controller 3 may include a memory unit 33, an information obtainment unit 34, an input voltage determination unit 35, an operating unit number determination unit 36, and an operation control signal transmission unit 37. The memory unit 33 may be implemented by at least part of the storage area in the memory 32 illustrated in FIG. 1. The functions of the information obtainment unit 34, the input voltage determination unit 35, the operating unit number determination unit 36, and the operation control signal transmission unit 37 may be embodied by operation of the FPGA 31 illustrated in FIG. 1 (including referencing to the memory 32) according to a circuit logic set within the FPGA 31.

The information obtainment unit 34 obtains various types of information from each of the plurality of power supply units 10. For example, the information obtainment unit 34 may obtain information such as the load rate β, the input voltage Vin, and the operation state of each power supply unit 10, based on a signal S1a and a voltage detection signal S5 received from the each power supply unit 10 via the signal line L1a.

The operation state may, for example, be determined to be the stop state when the load rate β is zero (or lower than and equal to a given threshold near zero) or the power supplying state when the load rate β is greater than zero or the given threshold. This is because the output current Iout is zero and thus the load rate β (output power value Po) also becomes zero, in the stop state. Alternatively, additional information indicating the power supplying state or the stop state, additional information indicating the magnitude of the output current Iout, etc. may be included in the signal S1a by the controller 15. By obtaining the operation state, the information obtainment unit 34 can identify power supply unit(s) 10 in operation, thereby obtaining the number of power supply units 10 that operate in parallel.

The input voltage determination unit 35 compares the input voltage Vin obtained by the information obtainment unit 34 with a given voltage threshold to determine whether the input voltage Vin is classified into High or Low. In the first embodiment, there are two classifications: “Low” where the voltage is lower than or equal to the given threshold, and “High” where the voltage is higher than the threshold. However, this is not limiting, and there may be three or more classifications.

The operating unit number determination unit 36 determines a trigger to increase or decrease the number of power supply units 10 in the power supplying state based on the load rates β and the input voltages Vin (e.g., the high or low classifications) obtained from the plurality of power supply units 10 and determines the number of power supply units 10 after the increase or decrease. It should be note that the operating unit number determination unit 36 may perform the processing at regular intervals.

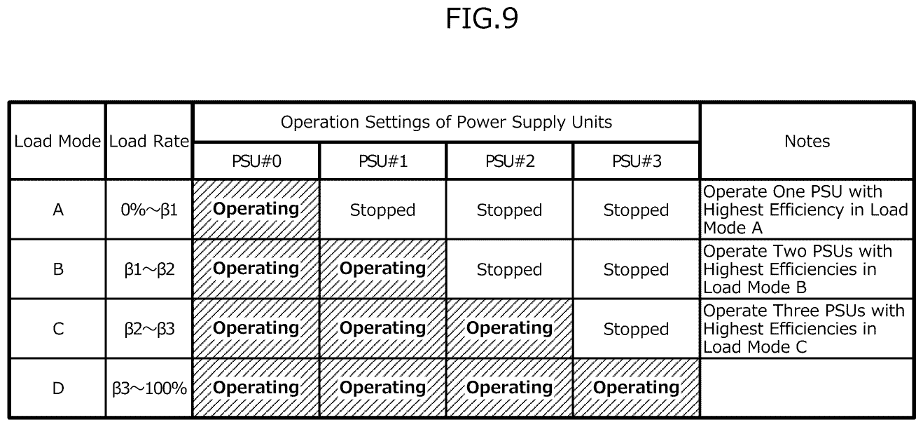

FIG. 9 is a diagram illustrating one example of the relationship between the load modes and the operation settings of power supply units 10. In FIG. 9, a power supply unit 10 may be labeled “PSU.” Power supply units 10 in the power supplying state (operating state) may be labeled as “Operating,” and power supply units 10 in the stop state may be labeled as “Stopped.”

The load modes define the number of power supply units 10 to be operated for the respective ranges (load rate ranges) of the load rate β. For example, the load mode A specifies that one power supply unit 10 (for example, the unit with the highest power conversion efficiency) is to be operated when the load rate β is from 0% to β1% (e.g., 0% or higher and less than β1%). The load mode B specifies that two power supply units 10 (for example, the top two power supply units 10 with highest power conversion efficiencies) are to be operated when the load rate β is from β1% to β2%. The load mode C specifies that three power supply units 10 (for example, the top three power supply units 10 with highest power conversion efficiencies) are to be operated when the load rate β is from β2% to β3%. The load mode D specifies that all of the four power supply units 10 are to be operated when the load rate β is from β3% to 100% (e.g., β3% or higher and 100% or lower).

The operating unit number determination unit 36 may determine the number of units to operate and the power supply unit(s) 10 to be set to the power supplying state to satisfy the conditions of the load mode illustrated in FIG. 9.

It should be noted that the power supply unit #0 is indicated as the power supply unit 10 to be operated in the load mode A in FIG. 9 for convenience. However, as described above, the power supply unit(s) 10 may be selected from power supply units 10 with highest power conversion efficiencies. The same applies to the load modes B and C.

Here, as described above, the peak value on the efficiency curve and the load rate at that peak vary depending on whether the input voltage Vin is high or low (see FIGS. 5 and 6). To adapt to such variations, in the first embodiment, the range of the load rate for each load mode is adjusted according to whether the input voltage Vin is classified into high or low.

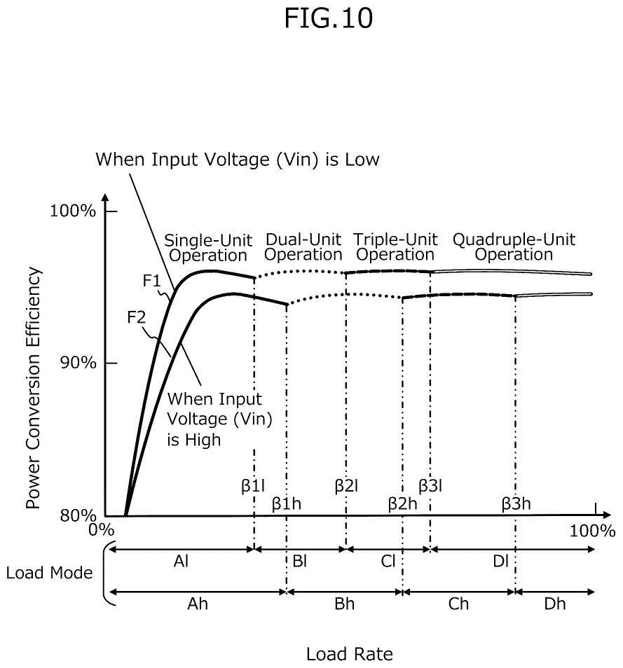

FIG. 10 is a diagram illustrating one example of the ranges of the load rates for load modes according to the input voltage Vin to the DC-DC converter 12. In FIG. 10, the ridgeline denoted by the symbol F1 represents the optimal efficiency curve of the power conversion efficiency and the load rate when the number of power supply units 10 is increased or decreased at the load rates β1l, β2l, and β3l when the input voltage Vin is low. The ridgeline denoted by the symbol F2 represents the optimal efficiency curve of the power conversion efficiency and the load rate when the number of power supply units 10 is increased or decreased at the load rates β1h, β2h, and β3h when the input voltage Vin is high.

As illustrated in FIG. 10, when the input voltage Vin is low, the trigger for switching from the load mode Al to Bl is when the load rate is β1l. Alternatively, when the input voltage Vin is high, the trigger for switching from the load mode Ah to Bh is when the load rate is β1h. In this manner, the trigger for switching between the load mode A (Al, Ah) and the load mode B (Bl, Bh) shifts by the load rate difference [β1h−β1l] when the high or low classification of the input voltage Vin varies.

The operating unit number determination unit 36 changes the trigger (load rate) for increasing or decreasing the number of units to operate according to the input voltage Vin, based on information indicating the correspondence relationship between the load rate and the power conversion efficiency for each input voltage Vin and for each number of units in operation (see FIG. 10). In other words, the operating unit number determination unit 36 determines the trigger for increasing or decreasing the number of power supply units 10 in the power supplying state based on the load rates β and the input voltages Vin obtained from the plurality of power supply units 10 and the correspondence relationship illustrated in FIG. 10. Then, in response to determining that the trigger for increasing or decreasing the number of units to operate is met, the operating unit number determination unit 36 determines a new number of power supply units 10 after the increase or decrease, based on the load rates β and the input voltages Vin obtained and the correspondence relationship.

The correspondence relationship illustrated in FIG. 10 may be stored in the memory unit 33 in advance as a power conversion efficiency table 33a, for example. The operating unit number determination unit 36 may refer to the power conversion efficiency table 33a stored in the memory unit 33 to determine the number of units to operate. The power conversion efficiency table 33a represents one example of information that indicates a correspondence relationship between the load rates for the processing device 4 and the power conversion efficiencies of the plurality of power supply units 10 at the load rates, for each input voltage Vin and for each number of power supply units 10 in the power supplying state.

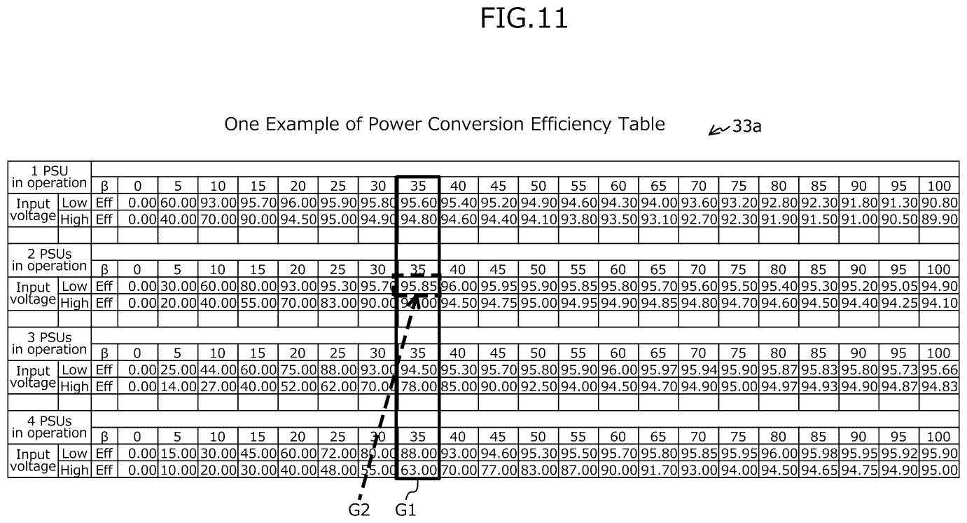

FIG. 11 is a diagram illustrating one example of the

power conversion efficiency table 33a. As illustrated in FIG. 11, the power conversion efficiency table 33a stores the load rate β and the power conversion efficiency for each number of operating power supply units 10 and for each high or low classification of the input voltage Vin. In FIG. 11, “x PSU(s) in operation” indicates that x power supply unit(s) 10 is (are) being operated (x is an integer from 1 to 4), “Input voltage” indicates the input voltage Vin. “Low” and “High” indicate the low and high classifications of the input voltage Vin, respectively. “β” indicates the load rate β, and “Eff” indicates the power conversion efficiency. Although FIG. 11 illustrates an example where numerical data are set in the power conversion efficiency table 33a, this is not limiting. Various types of information, such as modeled equations or computational results from external simulators, may be set to the memory unit 33 in place of or in addition to the numerical data illustrated in FIG. 11.

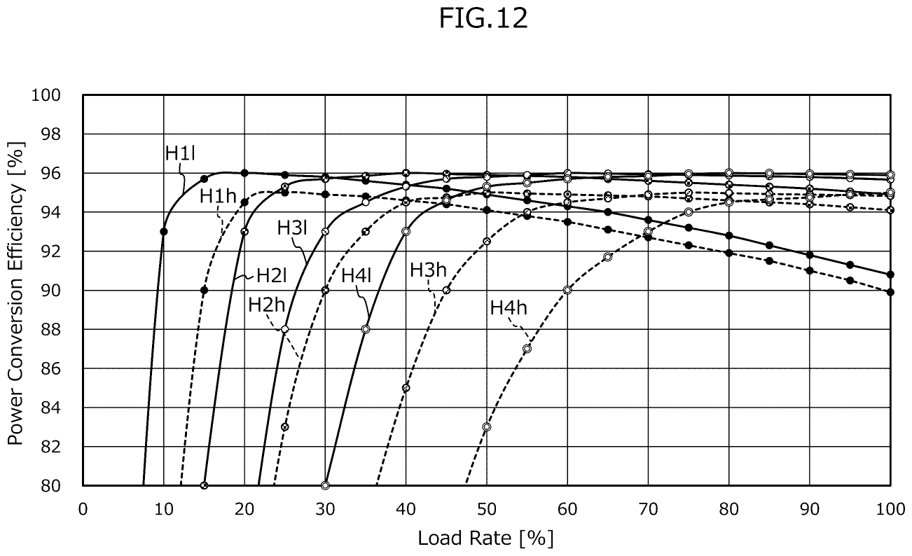

FIG. 12 is a diagram illustrating examples of efficiency curves represented by the power conversion efficiency table 33a. In FIG. 12, the symbols H1l and H1h denote the efficiency curves for single-unit operation when the high or low classification is “Low” and “High,” respectively. The symbols H2l and H2h denote the efficiency curves for dual-unit operation when the high or low classification is “Low” and “High,” respectively. The symbols H3l and H3h denote the efficiency curves for triple-unit operation when the high or low classification is “Low” and “High,” respectively. The symbols H4l and H4h denote the efficiency curves for quadruple-unit operation when the high or low classification is “Low” and “High,” respectively.

For example, it is assumed that the obtained load rate β is 35%, the obtained input voltage Vin is determined to be “Low,” and the obtained number of operating unit (number of units operating in parallel) is three.

The operating unit number determination unit 36 refers to the entries (rows) with “Input voltage” of “Low” in the power conversion efficiency table 33a and identifies the column where the load rate β is 35% (see the symbol G1). In the example illustrated in FIG. 11, when the input voltage Vin is low and the load rate β is 35%, the power conversion efficiency is 95.60% for single-unit operation, 95.85% for dual-unit operation, 94.50% for triple-unit operation, and 88.00% for quadruple-unit operation. The operating unit number determination unit 36 determines “dual-unit operation” to be the number of operating unit when the input voltage Vin is low and the load rate β is 35% to obtain the maximum power conversion efficiency of “95.85%” (see the symbol G2).

In this manner, the operating unit number determination unit 36 identifies the power conversion efficiency for each number of units corresponding to the obtained input voltage Vin and the obtained load rate β from the power conversion efficiency table 33a. Then, if the number of units (number of operating units) corresponding to a given power conversion efficiency (e.g., the maximum power conversion efficiency) among the identified multiple power conversion efficiencies differs from the number of currently operating power supply units 10, the operating unit number determination unit 36 determines that the trigger (timing) for increasing or decreasing the number of units is met. This enables precise determination of the trigger for increasing or decreasing the number of units to operate while adapting to changes in input voltage Vin.

For example, as illustrated in FIGS. 11 and 12, the power conversion efficiency table 33a is configured so that the trigger for increasing or decreasing the number of units varies according to the input voltage Vin. Consequently, the timing for increasing or decreasing the number of units can be determined with high precision while adapting to changes in input voltage Vin.

In response to determining that the trigger for increasing or decreasing the number of units is met, the operating unit number determination unit 36 identifies the power supply unit(s) 10 to be in the power supplying state so that, for example, the number of power supply units 10 in the power supplying state matches the determined number of units to operate. The operating unit number determination unit 36 may select, for example, a number of power supply units 10 equal to the difference between the number of units currently operating and the determined number of units to operate as the power supply unit(s) 10 to start or stop operation. If the [the number of units currently operating]<[the determined number of units to operate] holds true, power supply unit(s) 10 with highest power conversion efficiencies among power supply units 10 currently in the stopped state may be selected as power supply unit(s) 10 to start operation, for example. Conversely, if [the number of units currently operating]>[the determined number of units to operate] holds true, power supply unit(s) 10 with lowest power conversion efficiencies among power supplying units 10 currently in the power supplying state may be selected as power supplying unit(s) 10 to stop operation, for example.

In the example illustrated in FIG. 11, since the number of units currently operating is three and the determined number of units to operate is two, the operating unit number determination unit 36 selects the power supply unit 10 with the lowest power conversion efficiency among the currently operating power supply units 10 so that the operating unit number is reduced to two.

It should be noted that the example described above is not limiting, and the operating unit number determination unit 36 may also select power supply unit(s) 10 in the determined number of units to operate based on the power conversion efficiency among all power supply units 10 in the power supply or stopped state.

The operation control signal transmission unit 37, at the trigger determined by the operating unit number determination unit 36, sends on or off instructions to each of the plurality of power supply units 10 in the power supplying state so that the number of power supply units 10 in the power supplying state equals the determined number of units to operate.

For example, the operation control signal transmission unit 37 sends an operation control signal S1b (e.g., a low-level signal) via the signal line L1 (L1b) to each of the power supply units 10 identified by the operating unit number determination unit 36, thereby switching these operation control signals S1b to the power supplying state. On the other hand, the operation control signal transmission unit 37 sends an operation control signal S1b (e.g., a high-level signal) to each of the power supply units 10 not identified by the operating unit number determination unit 36, thereby switching these operation control signals S1b to the stop state. This allows the power supply controller 3 to flexibly switch the number of operating power supply units 10 based on the input voltage Vin, thereby improving the power efficiency across the entire apparatus 1.

### (A-4) Exemplary Operation

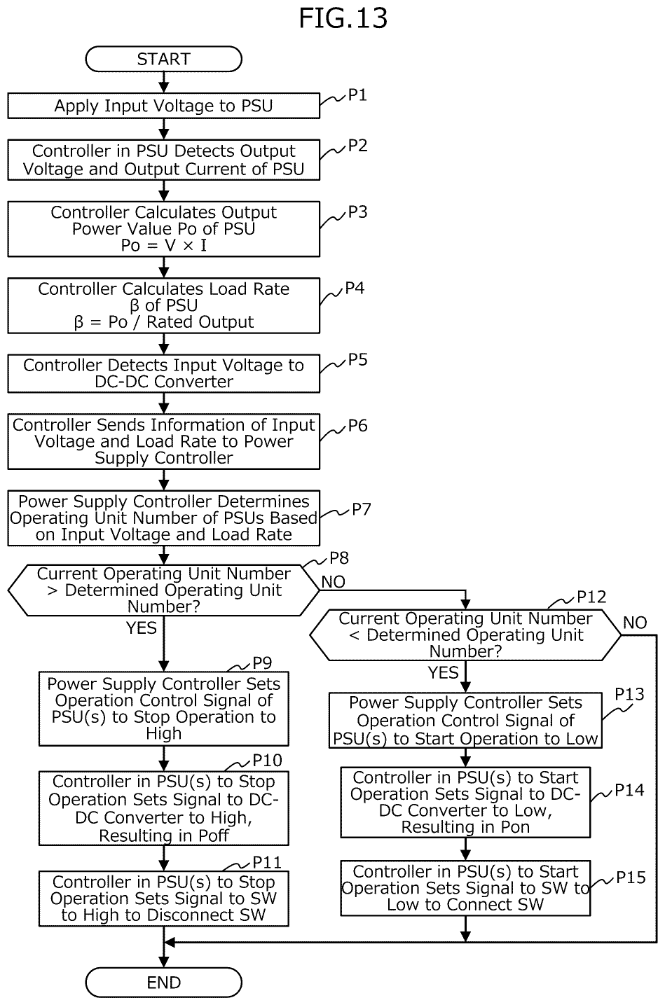

Next, an exemplary operation of the apparatus 1 according to the first embodiment will be explained. FIG. 13 is a flowchart for explaining an exemplary operation of the apparatus 1 according to the first embodiment.

As illustrated in FIG. 13, in Step P1, when AC power is supplied to the power supply unit 10 from the AC power source 2, the AC-DC converter 11 applies the input voltage Vin to the DC-DC converter 12.

In Step P2, the output current detector 13 detects the output current Iout from the DC-DC converter 12 to the output line Lp and outputs a current detection signal Is indicating the magnitude of the output current Iout, to the controller 15. The output voltage detector 14 detects the output voltage Vp applied to the output line Lp by the DC-DC converter 12 and outputs a voltage detection signal Vs indicating the magnitude of the output voltage Vp, to the controller 15. The controller 15 detects the output current value I and the output voltage value V of the power supply unit 10 from the current detection signal Is and the voltage detection signal Vs.

In Step P3, the controller 15 calculates the output power value Po of its local power supply unit 10 by multiplying the output voltage value V and the output current value I according to the above formula (1).

In Step P4, the controller 15 calculates the load rate β of its local power supply unit 10 by dividing the calculated output power value Po by the rated power value Pr, which is one example of the rated output value, according to the above formula (2).

In Step P5, the input voltage detector 17 detects the input voltage Vin to the DC-DC converter 12 and outputs a voltage detection signal S5 indicating the magnitude of the input voltage Vin, to the controller 15. The controller 15 detects the input voltage value to the DC-DC converter 12 from the voltage detection signal S5.

In Step P6, the controller 15 sends a voltage detection signal S5 that is information indicating the input voltage value, and a signal S1a that is information indicating the load rate β, to the power supply controller 3.

In Step P7, the operating unit number determination unit 36 in the power supply controller 3 determines the number of operating power supply units 10 by referring to the power conversion efficiency table 33a, based on the high or low classification of the input voltage Vin determined by the input voltage determination unit 35 according to the input voltage Vin and the load rate β.

In Step P8, the operating unit number determination unit 36 determines whether the number of units currently operating (for example, the number of power supply units 10 with a load rate β>0) is greater than the determined number of units to operate. If the number of units currently operating is greater than the determined number of units to operate (YES in Step P8), a trigger for decreasing the operating unit number is met. In this case, the processing transitions to Step P9.

In Step P9, the operating unit number determination unit 36 selects a number of power supply units 10 equal to [the number of units currently operating]−[the determined number of units to operate], from the power supply units 10 that are currently in the power supplying state. The selected power supply unit(s) 10 are the power supply unit(s) 10 to stop operation. The operation control signal transmission unit 37 sets the operation control signal S1b for the power supply unit(s) 10 to stop operation to the high level. For the power supply unit(s) 10 other than power supply unit(s) 10 to stop operation, the current value (level) of the operation control signal S1b is maintained as is. This prevents the power supply unit(s) 10 from supplying unnecessary power.

In Step P10, the controller 15 in power supply unit(s) 10 that receives the operation control signal S1b set to the high level sets the output setting signal S3 to the DC-DC converter 12 to the high level, thereby transitioning the DC-DC converter 12 to the stop state (Poff).

In Step P11, the controller 15 in power supply unit(s) 10 that receives the operation control signal S1b set to the high level sets the switch control signal S4 to the switch 16 to the high level, thereby controlling the switch 16 to the off (disconnected) state. By controlling the switch 16 to the OFF state, the signal line L2 between the power supply unit(s) 10 to stop operation and other power supply units 10 is disconnected, and the current balancing function of the power supply unit(s) 10 to stop operation is disabled. The processing is thus terminated.

If the number of units currently operating is equal to or less than the determined number of units to operate in Step P8 (NO in Step P8), the processing transitions to Step P12.

In Step P12, the operating unit number determination unit 36 determines whether the number of units currently operating is less than the determined number of units to operate. If the number of units currently operating is equal to the determined number of units to operate (NO in Step P12), the number of units currently operating is optimal and the process is terminated.

In Step P12, if the number of units currently operating is less than the determined number of units to operate (YES in Step P12), the trigger to increase the operating unit number is met. In this case, the processing transitions to Step P13.

In Step P13, the operating unit number determination unit 36 selects a number of power supply units 10 equal to [the determined number of units to operate]−[the number of units currently operating]. The selected power supply unit(s) 10 are the power supply unit(s) 10 to start operation. The operation control signal transmission unit 37 sets the operation control signals S1b for the power supply unit(s) 10 to start operation to the low level. For power supply unit(s) 10 other than power supply unit(s) 10 to start operation, the current value (level) of the operation control signal S1b is maintained as is. This allows only the power supply unit(s) 10 in the number suited for high-efficiency operation to continue supplying power.

In Step P14, the controller 15 in power supply unit(s) 10 that receives the operation control signal S1b set to the low level sets the output setting signal S3 to the DC-DC converter 12 to the low level, thereby transitioning the DC-DC converter 12 to the operating state (Pon).

In Step P15, the controller 15 in power supply unit(s) 10 that receives the operation control signal S1b set to the low level sets the switch control signal S4 to the switch 16 to the low level, thereby controlling the switch 16 to the on state (connected). By controlling the switch 16 to the on state, the signal line L2 between the power supply unit(s) 10 to start operation and other power supply units 10 is connected, and the current balancing function of the designated the power supply unit 10 is enabled. The processing is thus terminated.

### (A-5) Advantageous Effect of First Embodiment

According to the first embodiment, the power supply controller 3 includes the memory unit 33 configured to store the power conversion efficiency table 33a indicating the correspondence relationship between the load rates for the processing device 4 and the power conversion efficiencies of the plurality of power supply units 10 at the load rates, for each input voltage Vin and for each number of power supply units 10 in the operating state. Furthermore, the power supply controller 3 includes the control circuit. The control circuit is configured to determine a trigger for increasing or decreasing the number of power supply units 10 in the operating state based on the load rates β and the input voltages Vin obtained from the plurality of power supply units 10 and the correspondence relationship. Furthermore, the control circuit is configured to send, in response to determining that the trigger for increasing or decreasing the number of units is met, an instruction to turn on or off the power supplying state to each of the plurality of power supply units 10 so that the number of power supply units 10 in the operating state equals the number of units identified based on the load rates β and the input voltages Vin obtained and the correspondence relationship. This allows switching the number of power supply units 10 in the operating state at the optimal load rate to suppress a drop in the efficiency curve according to the input voltage Vin (e.g., according to whether the input voltage Vin is high or low). Consequently, it is possible to improve the power conversion efficiency while adapting to changes in input voltage Vin in not only individual power supply units 10 but also in the entire apparatus 1 (system).

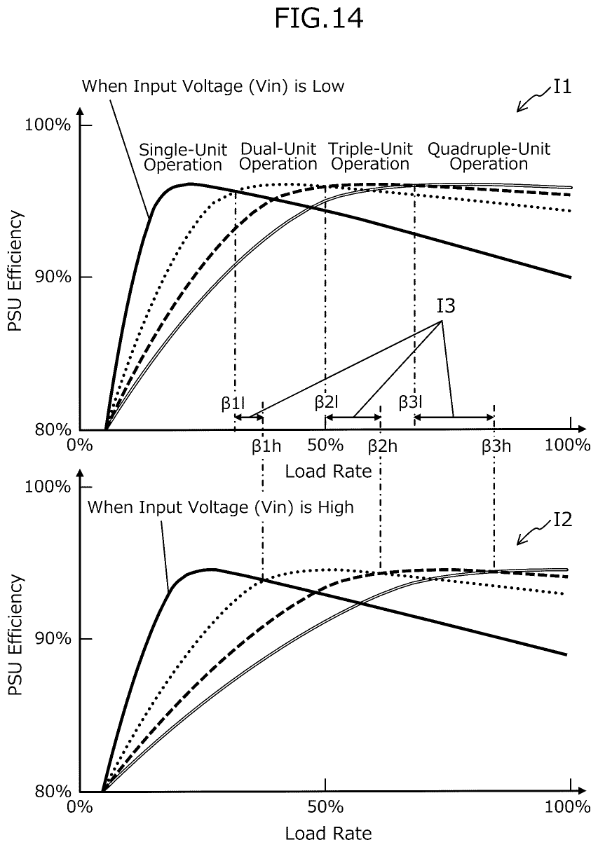

FIG. 14 is a diagram illustrating one example of the triggers for switching the operating unit number according to the input voltage Vin. The symbol I1 in FIG. 14 denotes the efficiency curve when the input voltage Vin is low, and the symbol I2 in FIG. 14 denotes the efficiency curve when the input voltage Vin is high.

As indicated by the symbols 13, according to the power supply controller 3 of the first embodiment, triggers for increasing or decreasing the number of units to operate β1l, β2l,β3l (when the input voltage Vin is low) and β1h, β2h, β3h (when the input voltage Vin is high) are switched according to the input voltage Vin. This reduces the likelihood of reduced efficiency, as indicated by the ridgeline D2 in FIG. 6, for example, and allows one or more power supply units 10 to operate within the high-efficiency range to achieve an optimal efficiency curve as the system, as indicated by the symbol F2 in FIG. 10, for example.

### (B) Second Embodiment

Next, a power supply unit 10A and a power supply controller 3A according to a second embodiment will be described. The power supply controller 3A represents one example of power supply control circuitry. In the first embodiment, the approach has been described in which the trigger for increasing or decreasing the number of units to operate is changed according to the input voltage Vin to the DC-DC converter 12. In the second embodiment, an approach will be described in which the trigger for increasing or decreasing the number of units to operate is changed according to the component temperature in the DC-DC converter 12.

### (B-1) Exemplary Configuration

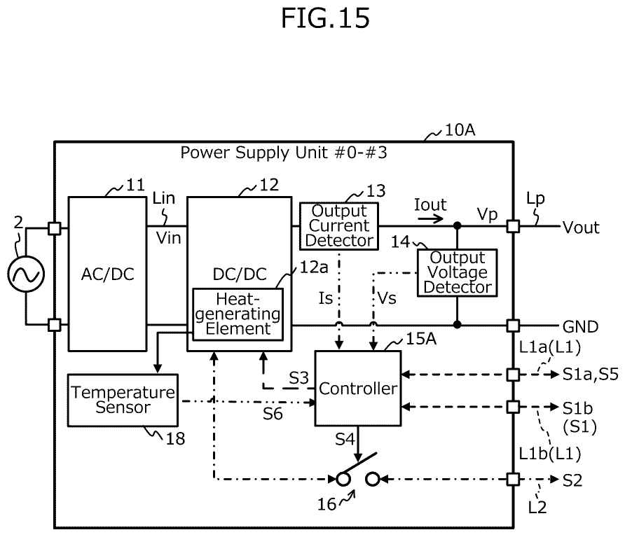

FIG. 15 is a block diagram illustrating an exemplary hardware configuration of a power supply unit 10A according to the second embodiment. The power supply unit 10A according to the second embodiment may be applied in place of the power supply unit 10 in the apparatus 1 illustrated in FIG. 1. Here, since the elements denoted by the same reference numerals as in the previously described elements are similar to those of the components previously described, descriptions thereof are omitted.

As illustrated in FIG. 15, the power supply unit 10A may include a temperature sensor 18 in place of the input voltage detector 17 of the power supply unit 10 (refer to FIG. 2). Additionally, the power supply unit 10A may include a controller 15A in place of the controller 15.

The temperature sensor 18 may be, for example, any of various sensors that measure the magnitude of the temperature, and outputs a temperature detection signal S6 indicating the magnitude of the component temperature Tj (temperature) generated in a heat-generating element 12a provided in the DC-DC converter 12 to the controller 15A. Examples of the heat-generating element 12a may include, for example, a semiconductor, such as a power semiconductor, as one example, a power conversion element. The temperature sensor 18 may be embodied by a thermoelectric conversion element such as a thermistor, for example.

The controller 15A calculates the load rate β of its local power supply unit 10A based on the current detection signal Is, the voltage detection signal Vs, and the rated output value of its local power supply unit 10A. Furthermore, the controller 15A sends (outputs) a temperature detection signal S6 along with a signal S1a indicating the load rate β, to the power supply controller 3A via the signal line L1a.

The control of the DC-DC converter 12 and the switch 16 by the controller 15A based on the operation control signal S1b supplied from the power supply controller 3A via the signal line L1b is similar to that by the controller 15.

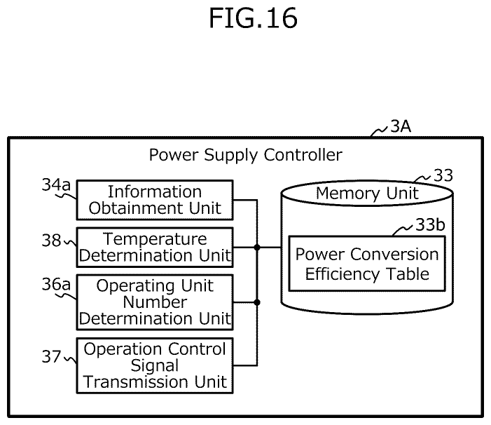

FIG. 16 is a block diagram illustrating an exemplary functional configuration of the power supply controller 3A according to the second embodiment. The power supply controller 3A according to the second embodiment may be applied in place of the power supply controller 3 illustrated in FIG. 8. Here, since the elements denoted by the same reference numerals as in the previously described elements are similar to those of the components previously described, descriptions thereof are omitted.

As illustrated in FIG. 16, the power supply controller 3A may include a temperature determination unit 38 in place of the input voltage determination unit 35 in the power supply controller 3 (see FIG. 8). The power supply controller 3A may also include an information obtainment unit 34a and an operating unit number determination unit 36a in place of the information obtainment unit 34 and the operating unit number determination unit 36 in the power supply controller 3.

The information obtainment unit 34a may obtain information such as the load rate β, the component temperature Tj, and the operating state of each power supply unit 10A based on a signal S1a and a temperature detection signal S6 received from the each power supply unit 10A via the signal line L1a.

The temperature determination unit 38 compares the component temperature Tj obtained by the information obtainment unit 34a with a given temperature threshold to determine whether the component temperature Tj is classified into High or Low. In the second embodiment, there are two classifications: “Low” where the temperature is lower than or equal to the given temperature threshold and “High” where the temperature is higher than the threshold. However, this is not limiting, and there may be three or more classifications.

The operating unit number determination unit 36a determines the number of power supply units 10A (operating unit number) to be in the power supplying state among the plurality of power supply units 10A based on the load rate β and component temperature Tj (e.g., the high or low classifications) obtained from the plurality of power supply units 10A.

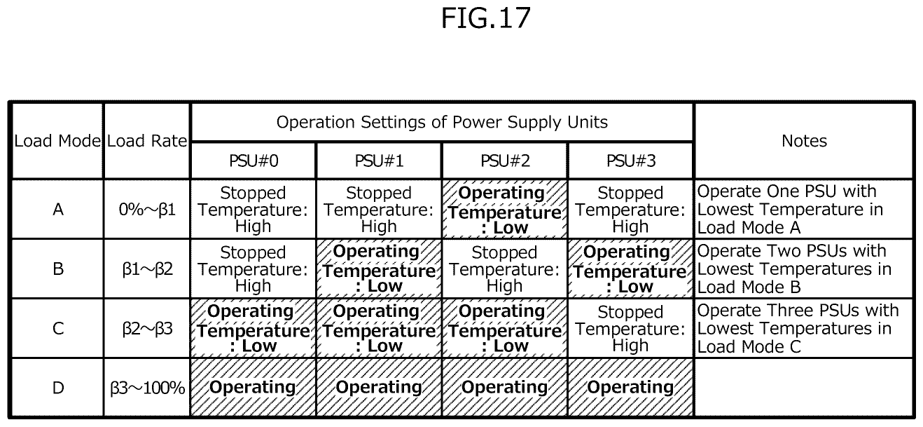

FIG. 17 is a diagram illustrating one example of the relationship between the load modes and the operation settings of the power supply units 10A. The load mode A illustrated in FIG. 17 specifies that one power supply unit 10 (for example, the power supply unit 10A with the lowest component temperature Tj) is to be operated when the load rate β is from 0% to β1%. The load mode B specifies that two power supply units 10 (for example, the top two power supply units 10A with the lowest component temperatures Tj) are to be operated when the load rate β is from β1% to β2%. The load mode C specifies that three power supply units 10 (for example, the top three power supply units 10A with the lowest component temperatures Tj) are to be operated when the load rate β is from β2% to β3%. The load mode D specifies that all of the four power supply units 10A are to be operated when the load rate β is from β3% to 100%.

The operating unit number determination unit 36a may determine the number of units to operate and the power supply unit(s) 10A to set to the power supplying state to satisfy the conditions of the load mode illustrated in FIG. 17.

The power supply unit #2 is indicated as the power supply unit 10A to be operated in the load mode A for convenience in FIG. 17. However, as described above, the power supply unit(s) 10A may be selected from power supply units 10A with lowest component temperatures Tj. The same applies to the load modes B and C.

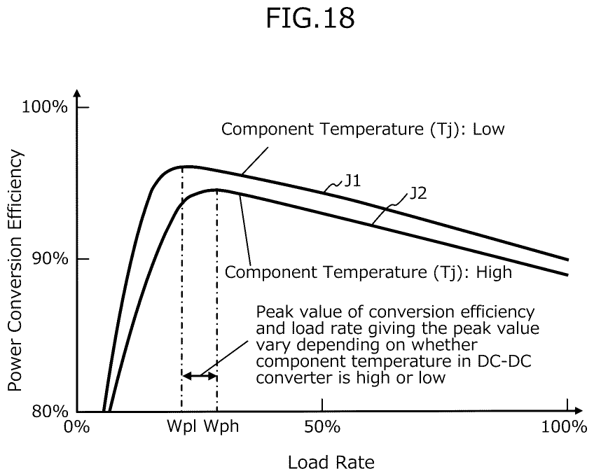

FIG. 18 is a graph indicating one example of the relationship between the power conversion efficiency and the load rate when the component temperature Tj in the DC-DC converter 12 varies. FIG. 18 illustrates the efficiency curves in cases where the component temperature Tj of the DC-DC converter 12 is low (symbol J1) and high (symbol J2) during single-unit operation of a power supply unit 10A.

As illustrated in FIG. 18, the peak value on the efficiency curve of the power supply unit 10A (power conversion efficiency) and the load rate giving this peak value vary depending on the component temperature Tj of the DC-DC converter 12. In FIG. 18, Wpl represents the load rate giving the peak value of the efficiency curve J1 when the component temperature Tj is relatively low compared to a given temperature threshold, and Wph represents the load rate giving the peak value of the efficiency curve J2 when the component temperature Tj is relatively high compared to the given temperature threshold. Although Wpl<Wph in the example of FIG. 18, Wpl>Wph may be applied depending on the specifications (characteristics) of the power supply unit 10A.

To adapt to such variations in the efficiency curve due to changes in component temperature Tj, the range of the load rate for each load mode is adjusted according to whether the component temperature Tj is classified into high or low in the second embodiment.

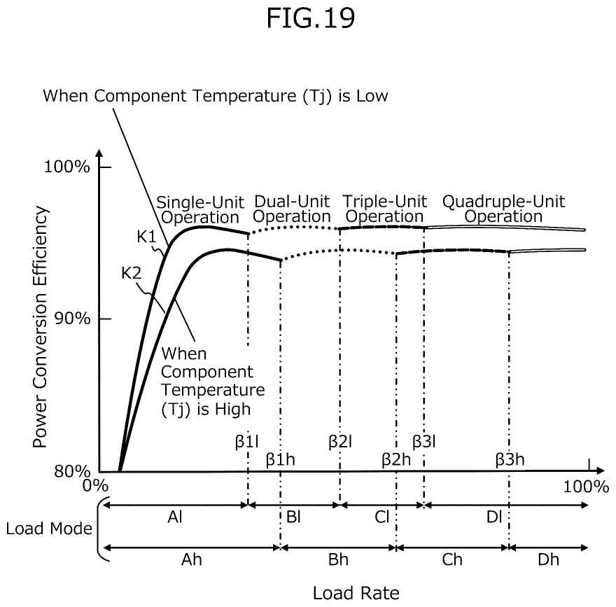

FIG. 19 is a diagram illustrating one example of the ranges of the load rates for load modes according to the component temperature Tj of the DC-DC converter 12. In FIG. 19, the ridgeline denoted by the symbol K1 represents the optimal efficiency curve of the power conversion efficiency and the load rate when the number of power supply units 10A is increased or decreased at the load rates β1l, β2l, and β3l when the component temperature Tj is low. The ridgeline denoted by the symbol K2 represents the optimal efficiency curve of the power conversion efficiency and the load rate when the number of power supply units 10A is increased or decreased at the load rates β1h, β2h, and β3h when the component temperature Tj is high.

As illustrated in FIG. 19, when the component temperature Tj is low, the trigger for switching from the load mode Al to Bl is when the load rate is β1l. In contrast, when the component temperature Tj is high, the trigger for switching from the load mode Ah to Bh is when the load rate is β1h. In this manner, the trigger for switching between the load mode A (Al, Ah) and the load mode B (Bl, Bh) shifts by the load rate difference [β1h−β1l] when the high or low classification of the component temperature Tj varies.

The operating unit number determination unit 36a changes the trigger (load rate) for increasing or decreasing the number of units to operate according to the component temperature Tj, based on information indicating the correspondence relationship between the load rate and the power conversion efficiency for each component temperature Tj and for each number of units in operation (see FIG. 19). In other words, the operating unit number determination unit 36a determines the trigger for increasing or decreasing the number of power supply units 10A in the power supplying state based on the load rates β and the component temperatures Tj obtained from the plurality of power supply units 10A and the correspondence relationship illustrated in FIG. 19. Then, in response to determining that the trigger for increasing or decreasing the number of units to operate is met, the operating unit number determination unit 36a determines a new number of power supply units 10A after the increase or decrease, based on the obtained load rates β and the component temperatures Tj obtained and the correspondence relationship.

The correspondence relationship illustrated in FIG. 19 may be stored in the memory unit 33 in advance as a power conversion efficiency table 33b, for example. The operating unit number determination unit 36a may refer to the power conversion efficiency table 33b stored in the memory unit 33 to determine the number of units to operate. The power conversion efficiency table 33b represents one example of information that indicates a correspondence relationship between the load rates for the processing device 4 and the power conversion efficiencies of the plurality of power supply units 10A at the load rates, for each component temperature Tj and for each number of power supply units 10A in the power supplying state.

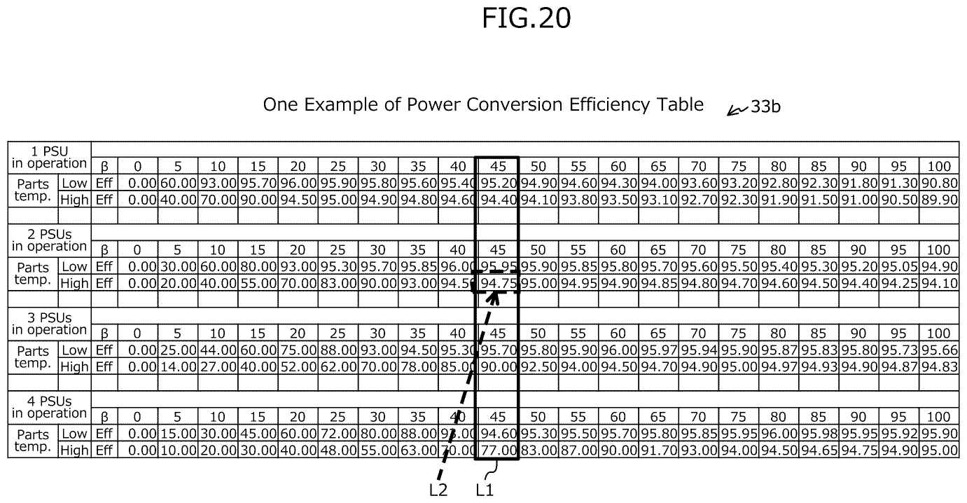

FIG. 20 is a diagram illustrating one example of the power conversion efficiency table 33b. As illustrated in FIG. 20, the power conversion efficiency table 33b stores the load rate β and the power conversion efficiency for each number of operating power supply units 10A and for each high or low classification of the component temperature Tj. In FIG. 20, “Parts temp.” indicates the component temperature Tj. Although FIG. 20 illustrates an example where numerical data are set in the power conversion efficiency table 33b, this is not limiting. Various types of information, such as modeled equations and computational results from external simulators, may also be set in the memory unit 33 in place of or in addition to the numerical data illustrated in FIG. 20.

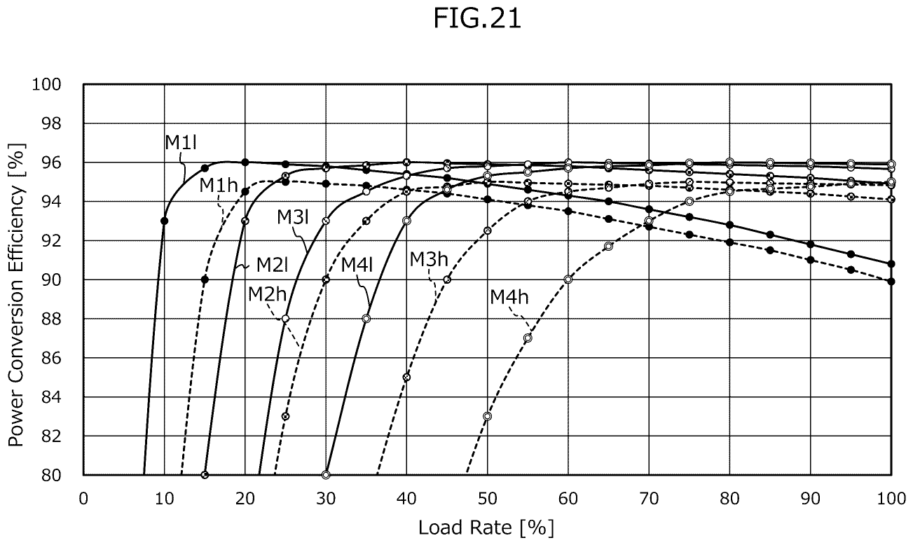

FIG. 21 is a diagram illustrating one example of efficiency curves represented by the power conversion efficiency table 33b. In FIG. 21, the symbols M1l and M1h denote the efficiency curves for single-unit operation when the high or low classification is “Low” and “High,” respectively. The symbols M2l and M2h denote the efficiency curves for dual-unit operation when the high or low classification is “Low” and “High,” respectively. The symbols M3l and M3h denote the efficiency curves for triple-unit operation when the high or low classification is “Low” and “High,” respectively. The symbols M4l and M4h denote the efficiency curves for quadruple-unit operation when the high or low classification is “Low” and “High,” respectively.

For example, it is assumed that the obtained load rate β is 45%, the obtained component temperature Tj is determined to be “High,” and the obtained number of operating unit (number of units operating in parallel) is three.

The operating unit number determination unit 36a refers to the entries (rows) with “Parts temp.” of “High” in the power conversion efficiency table 33b and identifies the column where the load rate β is 45% (see the symbol L1). In the example illustrated in FIG. 20, when the component temperature Tj is high and the load rate β is 45%, the power conversion efficiency is “94.40%” for single-unit operation, “94.75%” for dual-unit operation, “90.00%” for triple-unit operation, and “77.00%” for quadruple-unit operation. The operating unit number determination unit 36a determines “dual-unit operation” to be the number of operating unit when the component temperature Tj is high and the load rate β is 45% to obtain the maximum power conversion efficiency of 94.75% (see the symbol L2).

In this manner, the operating unit number determination unit 36a identifies the power conversion efficiency for each number of units corresponding to the obtained component temperature Tj and the obtained load rate β from the power conversion efficiency table 33b. Then, if the number of units (number of operating units) corresponding to a given power conversion efficiency (e.g., the maximum power conversion efficiency) among the identified multiple power conversion efficiencies differs from the number of currently operating power supply units 10A, the operating unit number determination unit 36a determines that the trigger (timing) for increasing or decreasing the number of units is met. This enables precise determination of the trigger for increasing or decreasing the number of units to operate while adapting to changes in component temperature Tj.

For example, as illustrated in FIGS. 20 and 21, the power conversion efficiency table 33b is configured so that the trigger for increasing or decreasing the number of units varies according to the component temperature Tj. Consequently, the timing for increasing or decreasing the number of units can be determined with high precision while adapting to changes in component temperature Tj.

In response to determining that the trigger for increasing or decreasing the number of units is met, the operating unit number determination unit 36 identifies the power supply unit(s) 10A to be in the power supplying state so that, for example, the number of power supply units 10A in the power supplying state matches the determined number of units to operate. The operating unit number determination unit 36a may select, for example, a number of power supply units 10A equal to the difference between the number of units currently operating and the determined number of units to operate as the power supply unit(s) 10A to start or stop operation. If the [the number of units currently operating]<[the determined number of units to operate] holds true, the power supply unit(s) 10A with low component temperatures Tj among power supply unit(s) 10A currently in the stopped state 10A may be selected as power supply unit(s) 10A to start operation, for example. Conversely, if [the number of units currently operating]>[the determined number of units to operate] holds true, the power supply unit(s) 10A with high component temperatures Tj among power supply units 10A currently in the power supplying state may be selected as power supply unit(s) 10A to stop operation, for example.

In the example illustrated in FIG. 20, since the number of units currently operating is three and the determined number of units to operate is two, the operating unit number determination unit 36a selects the power supply unit 10A with the highest component temperature Tj among the currently operating power supply units 10A so that the operating unit number is reduced to two.

It should be noted that the example described above is not limiting, and the operating unit number determination unit 36a may also select power supply unit(s) 10A in the determined number of units to operate based on the component temperature Tj among all power supply units 10A in the power supplying state or the stop states.

In the meantime, the component temperature Tj changes according to the operating state of the power supply unit 10A. For example, if the component temperature Tj of a power supply unit 10A in operation rises, the operating unit number determination unit 36a may switch to operate another power supply unit 10A with a lower component temperature Tj. If this is repeated, there is a possibility that the operating states of the plurality of power supply units 10A will be frequently switched.

To address this issue, the operating unit number determination unit 36a may, for example, refer to the power conversion efficiency table 33b and ensure a time interval (span) of at least a given duration to confirm switching of the number of units to operate. The given duration may be longer than a given cycle of the processing by the operating unit number determination unit 36 in the first embodiment (as one example, one minute or longer). This time interval may be set by the administrator of the apparatus 1 or others.

Alternatively, a hysteresis of a given temperature (e.g., 10° C.) may be added to the component temperature Tj in the determination to classify the component temperature Tj into high or low of by the temperature determination unit 38.

The power supply controller 3A may control so that the power supply units 10A to be set to the operating state are not switched frequently by using any of these approaches.

### (B-2) Exemplary Operation

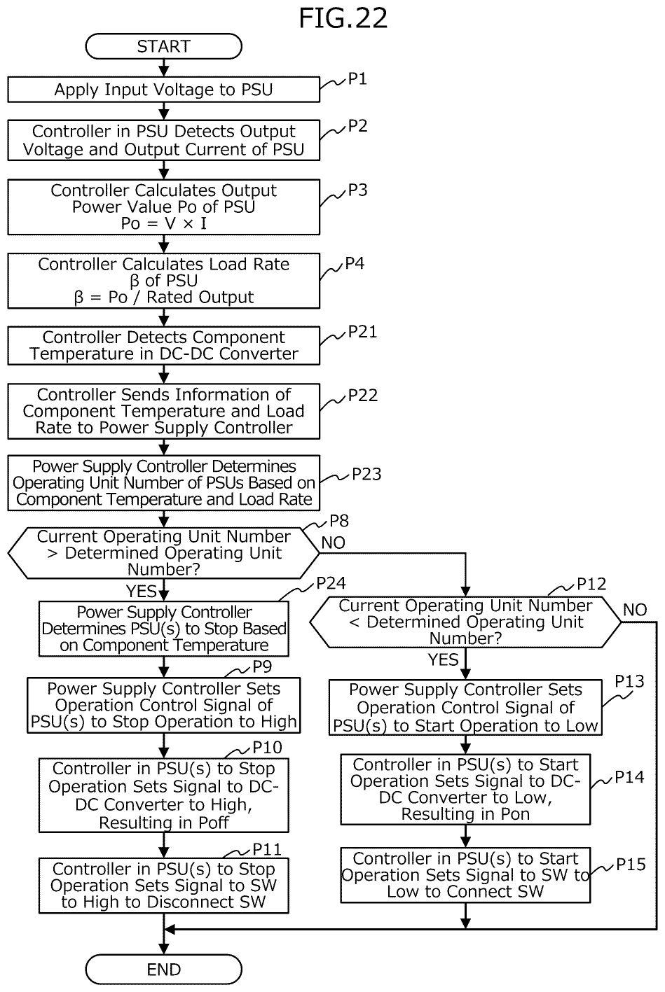

Next, an exemplary operation of the apparatus 1 according to the second embodiment will be explained. FIG. 22 is a flowchart for explaining an exemplary operation of the apparatus 1 according to the second embodiment.

The flowchart illustrated in FIG. 22 is different from the flowchart illustrated in FIG. 13 in that Steps P21 to P23 are executed in place of Steps P5 to P7. Additionally, the flowchart illustrated in FIG. 22 is different from the flowchart illustrated in FIG. 13 in that Step P24 is executed between Step P8 (YES) and Step P9. In the following, the steps denoted by the same symbols as the steps previously described are the same as previously described steps, and descriptions thereof are therefore omitted.

As illustrated in FIG. 22, in Step P21, the temperature sensor 18 detects the component temperature Tj of a heat-generating element 12a in the DC-DC converter 12 and outputs a temperature detection signal S6 indicating the magnitude of the component temperature Tj, to the controller 15A. The controller 15A detects the component temperature value of the DC-DC converter 12 from the temperature detection signal S6.

In Step P22, the controller 15A sends a temperature detection signal S6 that is information indicating the component temperature value, and a signal S1a that is information indicating the load rate β, to the power supply controller 3A.

In Step P23, the operating unit number determination unit 36a in the power supply controller 3A determines the number of operating power supply units 10A by referring to the power conversion efficiency table 33b, based on the high or low classification of the component temperature Tj determined by the temperature determination unit 38 according to component temperature Tj and the load rate β.

In Step P8, the operating unit number determination unit 36a determines whether the number of units currently operating is greater than the determined number of units to operate. If the number of units currently operating is greater than the determined number of units to operate (YES in Step P8), the processing transitions to Step P24.

In Step P24, the operating unit number determination unit 36a selects a number of power supply units 10A equal to [the number of units currently operating]−[the determined number of units to operate] from the power supply units 10A that are currently in the power supplying state. The selected power supply unit(s) 10A are the power supply unit(s) 10A to stop operation. At this time, the operating unit number determination unit 36a may preferentially select the power supply unit(s) 10A with highest component temperatures Tj. The processing then transitions to Step P9.

### (B-3) Advantageous Effect of Second Embodiment

According to the second embodiment, the power supply controller 3A includes the memory unit 33 configured to store the power conversion efficiency table 33b indicating the correspondence relationship between the load rates for the processing device 4 and the power conversion efficiencies of the plurality of power supply units 10A at the load rates, for each component temperature Tj and for each number of power supply units 10A in the operating state. Furthermore, the power supply controller 3A includes the control circuit. This control circuit is configured to determine a trigger for increasing or decreasing the number of power supply units 10A in the operating state based on the load rates β and component temperatures Tj obtained from the plurality of power supply units 10A and the correspondence relationship. Furthermore, the control circuit is configured to send, in response to determining that the trigger for increasing or decreasing the number of units is met, an instruction to turn on or off the power supplying state to each of the plurality of power supply units 10A so that the number of power supply units 10A in the operating state equals the number of units identified based on the load rates β and the component temperatures Tj obtained and the correspondence relationship. This allows switching the number of operating power supply units 10A in the operating state at the optimal load rate to suppress a drop in the efficiency curve according to the component temperature Tj (e.g., according to whether the component temperature Tj is high or low). Consequently, it is possible to improve the power conversion efficiency while adapting to changes in component temperature Tj in not only individual power supply units 10A but also in the entire apparatus 1 (system).

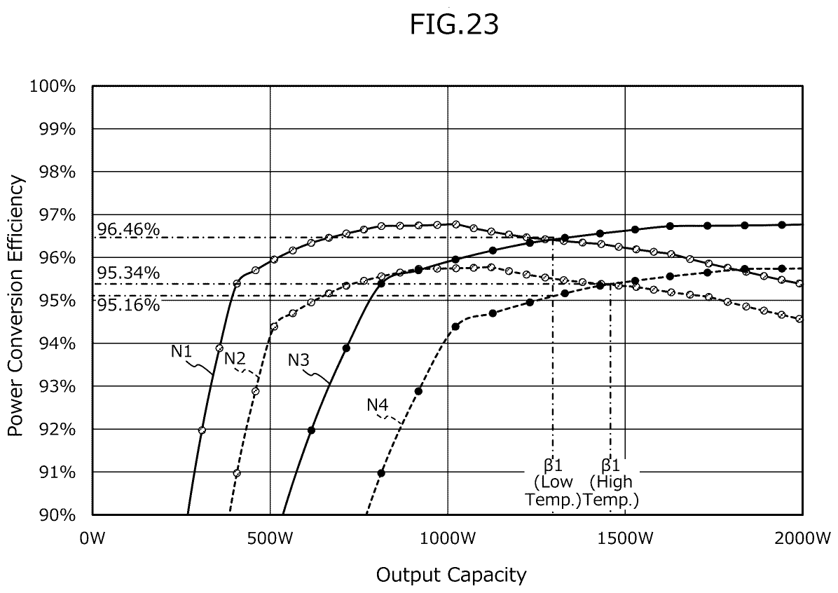

FIG. 23 is a diagram illustrating one example of power conversion efficiencies by switching the number of units to operate according to component temperature Tj. In FIG. 23, the symbol N1 denotes the efficiency curve for single-unit operation when the component temperature Tj is low, and the symbol N2 denotes the efficiency curve for single-unit operation when the component temperature Tj is high. The symbol N3 denotes the efficiency curve for dual-unit operation when the component temperature Tj is low, and the symbol N4 denotes the efficiency curve for dual-unit operation when the component temperature Tj is high.

As illustrated in FIG. 23, when power supply unit(s) 10A with lower component temperature(s) Tj is preferentially operated and the number of units to operate can be switched at the optimal load rate β1 in single-unit and dual-unit operations, the power conversion efficiency can be improved by approximately 1.3% from 95.16% to 96.46%. The loss can be improved by approximately 27.8% from 67.65 W to 48.81 W. When the efficiency difference due to the component temperature Tj is 1%, it is estimated that optimal switching of the number of units to operate based on load rate may improve the power conversion efficiency by 0.3% (improve the loss by approximately 4% from 67.65 W to approximately 65.01 W).

### (C) Third Embodiment

Next, a power supply unit 10B and a power supply controller 3B according to a third embodiment will be described. The power supply controller 3B represents one example of power supply control circuitry. In the third embodiment, an approach combining the approaches of the first and second embodiments will be described.

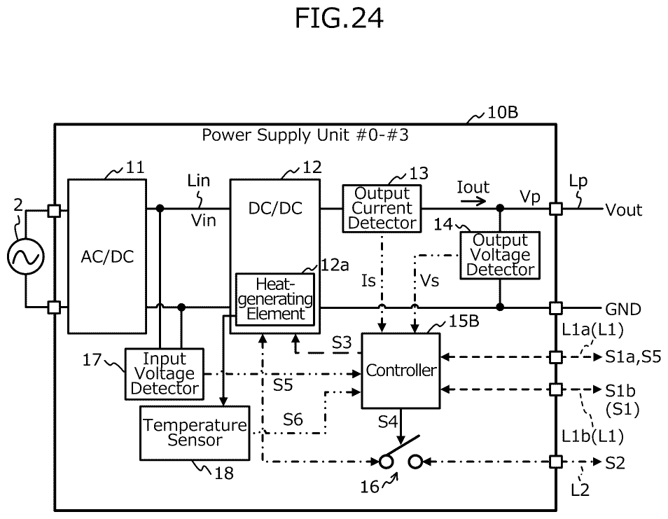

FIG. 24 is a block diagram illustrating an exemplary hardware configuration of a power supply unit 10B according to the third embodiment. The power supply unit 10B according to the third embodiment may be applied in the apparatus 1 illustrated in FIG. 1 in replacement of the power supply unit 10. Here, since the elements denoted by the same reference numerals as in the previously described elements are similar to those of the components previously described, descriptions thereof are omitted.

As illustrated in FIG. 24, the power supply unit 10B may include a temperature sensor 18 provided in the power supply unit 10A (see FIG. 15) in addition to the elements in the power supply unit 10 (see FIG. 2). The power supply unit 10B may also include a controller 15B in place of the controller 15.

The controller 15B calculates the load rate β of its local power supply unit 10B based on the current detection signal Is and the voltage detection signal Vs, and the rated output value of its local power supply unit 10B. Additionally, the controller 15B sends (outputs) a voltage detection signal S5 and a temperature detection signal S6 along with a signal S1a indicating the load rate β, to the power supply controller 3B via the signal line L1a.

The controls of the DC-DC converter 12 and the switch 16 by the controller 15B based on the operation control signal S1b supplied from the power supply controller 3B via the signal line L1b is similar to those by the controller 15.

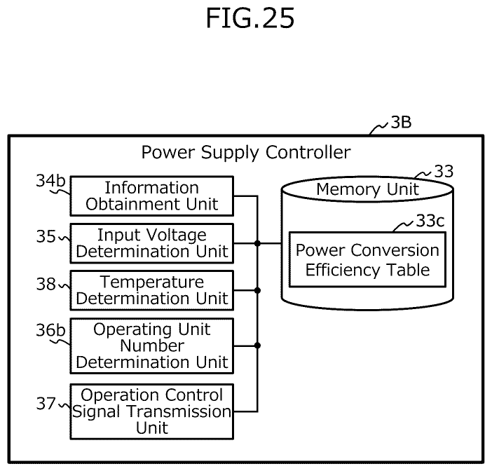

FIG. 25 is a block diagram illustrating an exemplary functional configuration of the power supply controller 3B according to the third embodiment. The power supply controller 3B according to the third embodiment may be applied in replacement of the power supply controller 3 illustrated in FIG. 8. Here, since the elements denoted by the same reference numerals as in the previously described elements are similar to those of the components previously described, descriptions thereof are omitted.

As illustrated in FIG. 25, the power supply controller 3B may include a temperature determination unit 38 provided in the power supply controller 3A (see FIG. 16) in addition to the elements in the power supply controller 3 (see FIG. 8). The power supply controller 3B may also include an information obtainment unit 34b and an operating unit number determination unit 36b in place of the information obtainment unit 34 and the operating unit number determination unit 36 in the power supply controller 3.

The information obtainment unit 34b may obtain information such as the load rate β, the input voltage Vin, the component temperature Tj, and the operating state based on the signal S1a, the voltage detection signal S5, and the temperature detection signal S6 received from each power supply unit 10B via the signal line L1a.

The operating unit number determination unit 36b determines the number of power supply units 10B (operating unit number) to be in the power supplying state among the plurality of power supply units 10B based on the load rate β, the high or low classification of the input voltage Vin, and the high or low classification of the component temperature Tj.

For example, the operating unit number determination unit 36b may determine the number of units to operate by referring to the power conversion efficiency table 33c stored in the memory unit 33. The power conversion efficiency table 33c represents one example of information indicating the correspondence relationship between the load rates for the processing device 4 and the power conversion efficiency of the plurality of power supply units 10B at the load rates, for each input voltage Vin, for each component temperature Tj, and for each number of power supply units 10 in the power supplying state. For example, the power conversion efficiency table 33c may be information in which the correspondence relationship between the load rate and the power conversion efficiency is set further for each high or low classification of component temperature Tj in each high or low classification of the input voltage Vin, in each number of units in operation in the power conversion efficiency table 33a illustrated in FIG. 11.

The operating unit number determination unit 36b may refer to the power conversion efficiency table 33c based on the input voltages Vin and the component temperatures Tj obtained, and the load rates β. This allows switching the number of units in operation at the optimal load rate to suppress a drop in the efficiency curve according to whether the input voltage Vin is high or low and whether the component temperature Tj is high or low.

It should be noted that the third embodiment is not limited to the approach described above, and may be configured to selectively perform either the approach based on whether the input voltage Vin is high or low according to the first embodiment or the approach based on whether the component temperature Tj is high or low according to the second embodiment, for example. In this case, both the power conversion efficiency table 33a (see FIG. 11) and the power conversion efficiency table 33b (see FIG. 20) may be stored in the memory unit 33.

### (D) Miscellaneous

The techniques according to the first to third embodiments described above may be embodied by modifying or changing them as follows.

For example, in each of the power supply unit 10 illustrated in FIG. 2, the power supply unit 10A illustrated in FIG. 15, and the power supply unit 10B illustrated in FIG. 24, each hardware element may be combined or divided in any combination. Similarly, in each of the power supply controller 3 illustrated in FIG. 8, the power supply controller 3A illustrated in FIG. 16, and the power supply controller 3B illustrated in FIG. 25, each functional element may be combined or divided in any combination.

In one aspect, the present disclosure can improve the power efficiency of the power supply unit.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. Power supply control circuitry configured to control a plurality of power supply units connected to a load, the power supply control circuitry comprising:
a storing device configured to store information indicating a correspondence relationship between load rates for the load and power conversion efficiencies of the plurality of power supply units at the load rates, for each input voltage input to a voltage converter provided in each of the plurality of power supply units and configured to output an output voltage to the load, and for each number of power supply units in a power supplying state for supplying power to the load;
control circuitry configured to determine a trigger for increasing or decreasing a number of power supply units in the power supplying state, based on the load rates and the input voltages obtained from the plurality of power supply units and the correspondence relationship, and to send, in response to determining that the trigger for increasing or decreasing the number of units is met, an instruction to turn on or off the power supplying state to each of the plurality of power supply units so that the number of power supply units in the power supplying state matches a number of units identified based on the load rates and the input voltages obtained and the correspondence relationship.

2. The power supply control circuitry according to claim 1, wherein
the control circuitry is configured to:
identify the power conversion efficiency for each number of units corresponding to the obtained input voltages and the obtained load rates, based on the correspondence relationship, and
determine that the trigger for increasing or decreasing the number of units is met when a number of units corresponding to a given power conversion efficiency among the identified plurality of power conversion efficiencies differs from the number of power supply units in the power supplying state.

3. The power supply control circuitry according to claim 2, wherein
the control circuitry is configured to send, in response to determining that the trigger for increasing or decreasing the number of units is met, the instruction to each of the plurality of power supply units so that the number of power supply units in the power supplying state matches the number of units corresponding to the given power conversion efficiency.

4. The power supply control circuitry according to claim 2, wherein
the correspondence relationship is set so that the trigger for increasing or decreasing the number of units varies according to the input voltage.

5. The power supply control circuitry according to claim 1, wherein
the information further indicates the correspondence relationship for each temperature of the voltage converter, and
the control circuitry is configured to determine the trigger for increasing or decreasing the number of units further based on the temperatures obtained from the plurality of power supply units, and to send, in response to determining that the trigger for increasing or decreasing the number of units is met, the instruction to each of the plurality of power supply units so that the number of power supply units in the power supplying state matches the number of unit identified further based on the obtained temperatures.

6. Power supply control circuitry configured to control a plurality of power supply units connected to a load, the power supply control circuitry comprising:
a storing device configured to store information indicating a correspondence relationship between load rates for the load and power conversion efficiencies of the plurality of power supply units at the load rates, for each temperature of a voltage converter provided in each of the plurality of power supply units and configured to output an output voltage to the load, and for each number of power supply units in a power supplying state supplying power to the load;
control circuitry configured to determine a trigger for increasing or decreasing a number of power supply units in the power supplying state, based on the load rates and the temperatures obtained from the plurality of power supply units and the correspondence relationship, and to send, in response to determining that the trigger for increasing or decreasing the number of units is met, an instruction to turn on or off the power supplying state to each of the plurality of power supply units so that the number of power supply units in the power supplying state matches a number of units identified based on the load rates and the temperatures obtained and the correspondence relationship.

7. The power supply control circuitry according to claim 6, wherein
the control circuitry is configured to:
identify the power conversion efficiency for each number of units corresponding to the obtained temperatures and the obtained load rates, based on the correspondence relationship, and
determine that the trigger for increasing or decreasing the number of units is met when a number of units corresponding to a given power conversion efficiency among the identified plurality of power conversion efficiencies differs from the number of power supply units in the power supplying state.

8. The power supply control circuitry according to claim 7, wherein
the control circuitry is configured to send, in response to determining that the trigger for increasing or decreasing the number of units is met, the instruction to each of the plurality of power supply units so that the number of power supply units in the power supplying state matches the number of units corresponding to the given power conversion efficiency.

9. The power supply control circuitry according to claim 7, wherein
the correspondence relationship is set so that the trigger for increasing or decreasing the number of units varies according to the temperature.

10. An information processing apparatus comprising:
a load;
a plurality of power supply units connected to the load; and
power supply control circuitry configured to control the plurality of power supply units,
each of the plurality of power supply units comprising
a voltage converter configured to output an output voltage to the load, and
the power supply control circuitry comprising:
a storing device configured to store information indicating a correspondence relationship between load rates for the load and power conversion efficiencies of the plurality of power supply units at the load rates, for each input voltage input to the voltage converter, and for each number of power supply units in a power supplying state for supplying power to the load;
control circuitry configured to determine a trigger for increasing or decreasing a number of power supply units in the power supplying state, based on the load rates and the input voltages obtained from the plurality of power supply units and the correspondence relationship, and to send, in response to determining that the trigger for increasing or decreasing the number of units is met, an instruction to turn on or off the power supplying state to each of the plurality of power supply units so that the number of power supply units in the power supplying state matches a number of units identified based on the load rates and the input voltages obtained and the correspondence relationship.

11. The information processing apparatus according to claim 10, wherein
the control circuitry is configured to:
identify the power conversion efficiency for each number of units corresponding to the obtained input voltages and the obtained load rates, based on the correspondence relationship, and
determine that the trigger for increasing or decreasing the number of units is met when a number of units corresponding to a given power conversion efficiency among the identified plurality of power conversion efficiencies differs from the number of power supply units in the power supplying state.

12. The information processing apparatus according to claim 11, wherein
the control circuitry is configured to send, in response to determining that the trigger for increasing or decreasing the number of units is met, the instruction to each of the plurality of power supply units so that the number of power supply units in the power supplying state matches the number of units corresponding to the given power conversion efficiency.

13. The information processing apparatus according to claim 11, wherein
the correspondence relationship is set so that the trigger for increasing or decreasing the number of units varies according to the input voltage.

14. The information processing apparatus according to claim 10, wherein
the information further indicates the correspondence relationship for each temperature of the voltage converter, and
the control circuitry is configured to determine the trigger for increasing or decreasing the number of units further based on the temperatures obtained from the plurality of power supply units, and to send, in response to determining that the trigger for increasing or decreasing the number of units is met, the instruction to each of the plurality of power supply units so that the number of power supply units in the power supplying state matches the number of unit identified further based on the obtained temperatures.
